(19) United States
(12) Patent Application Publication
(10) Pub. No.: US 2023/0405856 A1
(43) Pub. Date: Dec. 21, 2023

(54) RAZOR CARTRIDGE

(71) Applicant: DORCO CO., LTD., Seoul (KR)

(72) Inventor: Min Joo PARK, Seoul (KR)

(21) Appl. No.: 18/336,293

(22) Filed: Jun. 16, 2023

(30) Foreign Application Priority Data
Jun. 17, 2022 (KR) 10-2022-0074328
May 19, 2023 (KR) 10-2023-0064840

(51) Int. Cl. B26B 21/56; B26B 21/40

(52) U.S. Cl. CPC B26B 21/565; B26B 21/4031; B26B 21/60

(57) ABSTRACT

A razor cartridge is proposed. The razor cartridge may include at least one blade having an edge portion and a cutting edge formed at the tip of the edge portion. The at least one blade may include a substrate comprising a substrate tip and a coating layer formed on the substrate to form the cutting edge. The coating layer may include a first facet extending toward one side from a final edge forming a tip of the cutting edge, to face a skin surface during shaving and a second facet extending toward the other side from the final edge to opposite to the first facet. A blade angle between the skin surface and a line passing through a bisector of the edge portion may be greater than an efficient angle between the skin surface and a line passing through a bisector of the final tip.

### CROSS REFERENCE TO RELATED APPLICATIONS

This application claims the benefit of Korean Patent Application Nos. 10-2022-0074328, filed on Jun. 17, 2022, and 10-2023-0064840, filed on May 19, 2023, the contents of which are all hereby incorporated by reference herein in their entirety.

### BACKGROUND

### Technical Field

The present disclosure relates to a razor cartridge, and more particularly, to a razor cartridge used in a disposable razor or a cartridge replaceable razor.

### Description of Related Technology

A razor is a product generally used to cut and remove hair, such as facial hair, body hair, and beards. Typically, the razor consists of a handle to be gripped by a user, and a razor cartridge having a razor blade that come into contact with a skin surface to perform the act of shaving according to movement of the user's holding the handle. Such a razor includes a disposable razor in which the razor cartridge is not replaceable, and a cartridge replaceable razor in which a razor cartridge is selectively exchangeable by the user.

### SUMMARY

An aspect of the present disclosure provides a razor cartridge with a blade improved in shape so as to have an asymmetrical shape in which a thicknesses from one side facing skin surface and the other opposite side differs based on a center line of a cross section of the blade.

In one aspect, there is provided a razor cartridge including: at least one blade having an edge portion and a cutting edge formed at a tip of the edge portion; and a blade housing for receiving the at least one blade in a longitudinal direction so that at least a portion of the cutting edge is exposed through a top of the blade housing. The at least one blade includes: a substrate comprising a substrate tip, a first surface extending toward one side from the substrate tip, and a second surface extending toward the other side from the substrate tip; and a coating layer formed on the substrate to form the cutting edge, and comprising a first facet extending toward one side from a final edge forming a tip of the cutting edge, to face a skin surface during shaving and a second facet extending toward the other side from the final edge to opposite to the first facet. A blade angle between the skin surface and a line passing through a bisector of the edge portion is greater than an efficient angle between the skin surface and a line passing through a bisector of the final tip.

The efficient angle may be less than 10 degrees.

The blade angle may be 22 degrees or less.

The blade angle may be 17 degrees or less.

The final tip may be spaced apart from the skin surface during shaving.

The first facet may be formed within 1 micrometer of the final tip.

The second facet may be formed within 50 micrometers from the final tip.

An angle between the first facet and the second facet may have a value between 50 degrees and 75 degrees.

The blade may further include a third facet extending from the first facet, and an angle between the first facet and the third facet may have a value between 120 degrees and 165 degrees.

The blade may further include a third facet extending from the first facet, and an angle between an extension line of the second facet and an extension line of the third facet may have a value between 25 degrees and 50 degrees.

The blade may further include a third facet extending from the first facet, and the third facet may be formed within 50 micrometers from the final tip.

The blade may further include a third facet extending from the first facet and a fifth facet extending from the third facet. A point where the third facet and the fifth facet cross each other may be defined as a first intersection point. A point where a parallel line to the skin surface and passing through the first intersection point and a line passing through the bisector of the final tip cross each other may be defined as a second intersection point. A distance between the first intersection point and the second intersection point may have a value between 1 micrometer and 5 micrometers.

A distance between the second intersection point and the final tip may have a value between 2 micrometers and 7 micrometers.

In another aspect, there is provided a razor cartridge including at least one blade having an edge portion and a cutting edge formed at a tip of the edge portion; and a blade housing for receiving the at least one blade in a longitudinal direction so that at least a portion of the cutting edge is exposed through a top of the blade housing. The at least one blade includes: a substrate comprising a substrate tip, a first surface extending toward one side from the substrate tip, and a second surface extending toward the other side from the substrate tip; and a coating layer formed on the substrate to form the cutting edge, and comprising a first facet extending toward one side from a final edge forming a tip of the cutting edge, to face a skin surface during shaving and a second facet extending toward the other side from the final edge to opposite to the first facet. An efficient angle between the skin surface and a line passing through a bisector of the final tip is less than 10 degrees.

Details of other embodiments are included in the detailed description and drawings.

The effects of the razor cartridge according to the present disclosure are as follows.

Accordingly, in a case where the cutting edge of the blade is formed asymmetrically, the blade angle between the skin surface and the line passing through the bisector of the edge portion is greater than the efficient angle between the skin surface and the line passing through the bisector of the final tip, so that a cutting force can be reduced according to shaving characteristics and irritation to the skin surface can be minimized.

### BRIEF DESCRIPTION OF THE DRAWINGS

FIG. 1 is a schematic side view of a razor.

FIG. 2 is a plan view of a razor cartridge according to an embodiment of the present disclosure shown in FIG. 1.

FIG. 3 is a cross-sectional view taken along line III-III shown in FIG. 2.

FIG. 4 is a view showing a configuration of a blade shown in FIG. 3.

FIG. 5 is an enlarged cross-sectional view of area A shown in FIG. 4.

FIG. 6 is a chart showing the optimum thickness for a substrate shown in FIG. 5.

FIG. 7 shows an operational mechanism of interaction between a razor cartridge blade and a skin surface during shaving according to an embodiment of the present disclosure.

FIG. 8 is a vector diagram of shaving using a razor cartridge according to an embodiment of the present disclosure.

FIG. 9 is a test result table of shaving using a razor cartridge according to an embodiment of the present disclosure.

FIG. 10 is a cross-sectional view of characteristics of a shape of a cutting area of a razor cartridge according to an embodiment of the present disclosure.

### DETAILED DESCRIPTION

A razor cartridge includes at least one blade disposed transversely to a shaving direction to cut body hair and a blade housing for accommodating the blade in a longitudinal direction. A cutting edge for substantially cutting hair is formed at a tip of a blade, and the cutting edge is exposed upward of the blade housing.

Meanwhile, during shaving, the user may feel a comfortable saving sensation according to the cutting force. The cutting force generally refers to a cutting resistance between the body hair and the blade during hair cutting. The smaller the cutting force is, the more efficiently the body hair is cut and the more comfortable the user feels during shaving.

In detail, the blade includes a substrate used as a base material, a metal coating layer and a resin coating layer staked on the substrate, and the cutting force of the blade is based on the shape constituting the blade. For example, if the thickness of the substrate is thinner, the cutting force of the blade is further reduced, thereby enabling efficient cutting of the body hair and providing the user with a comfortable shaving sensation. Also, in another example, the cutting force of the blade depends on the cross-sectional shape of the blade that constitutes one side facing the skin surface and the other side opposite.

However, in a blade, a metal coating layer and a resin coating layer staked from both sides of the substrate are formed in a symmetrical shape of the same thickness. Such a blade having a symmetrical shape has a limitation in improving the cutting force and durability of the blade due to the characteristics of one side facing the skin surface to cut body hair and the opposite side facing away from the skin surface.

Hereinafter, a razor cartridge according to an embodiment of the present disclosure will be described in detail with reference to the accompanying drawings.

Prior to description, it should be noted in advance that the razor cartridge according to an embodiment of the present disclosure may be inseparably coupled to or integrally formed with a handle of a disposable razor, and may be selectively coupled to a handle of a cartridge replaceable razor.

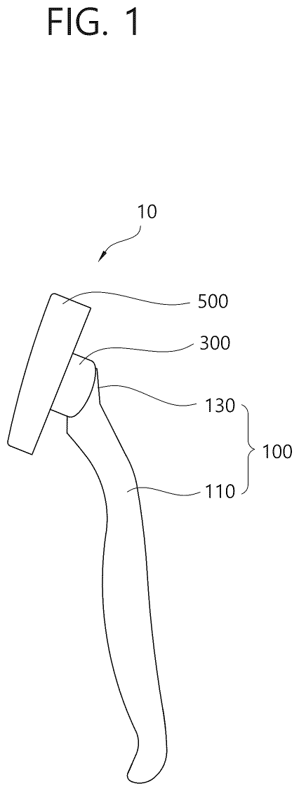

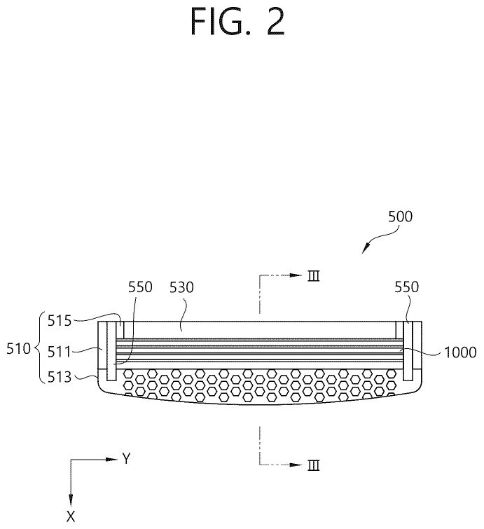

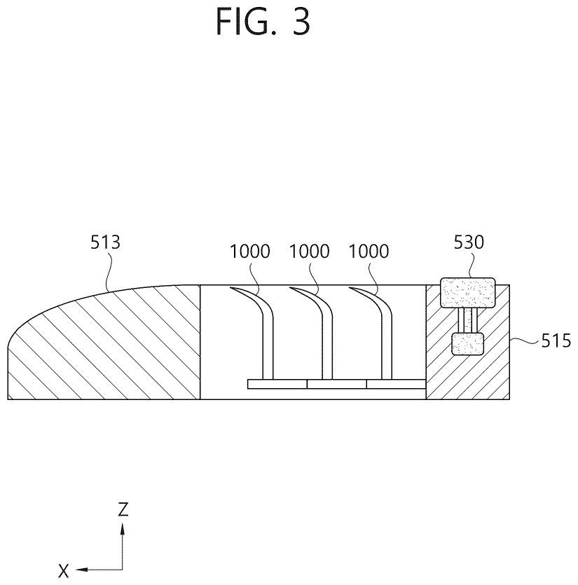

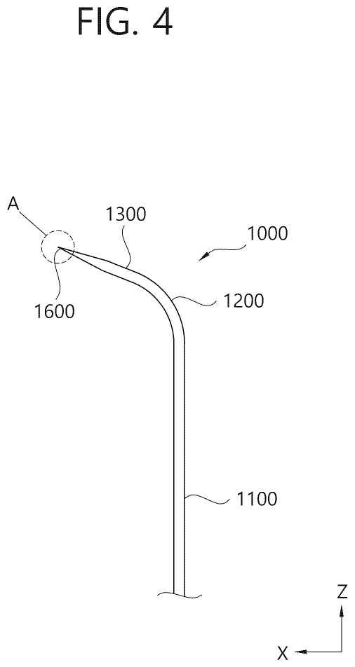

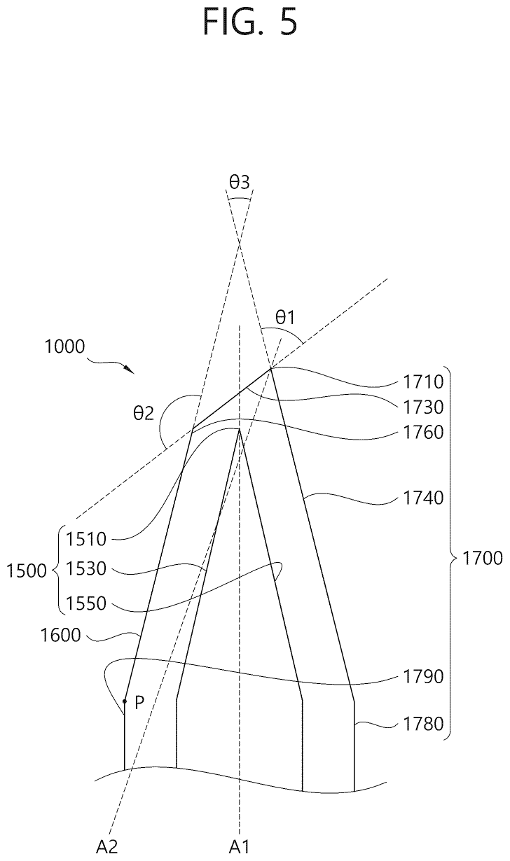

FIG. 1 is a schematic side view of a razor 10, FIG. 2 is a plan view of a razor cartridge 500 according to an embodiment of the present disclosure shown in FIG. 1, FIG. 3 is a cross-sectional view taken along line III-III shown in FIG. 2, and FIG. 4 is a view showing a configuration of a blade 1000 shown in FIG. 3, and FIG. 5 is an enlarged cross-sectional view of area A shown in FIG. 4.

As shown in FIGS. 1 to 4, the razor 10 includes a handle 100, a handle coupling part 300, and a razor cartridge 500 according to an embodiment of the present disclosure.

The handle 100 is gripped by a user. The handle 100 includes a handle body 110 and a handle header 130.

The handle body 110 is a part of razor 10 gripped by the user. The handle header 130 may be provided at one end of the handle body 110 and detachably coupled to the razor cartridge 500. Also, the handle body 110 pivotably supports the selectively coupled razor cartridge 500. Here, in the case of a disposable razor, the handle body 110 is inseparably coupled to or integrally formed with the razor cartridge 500.

The handle header 130 is coupled to the handle coupling part 300 formed under the razor cartridge 500. The handle header 130 is coupled to the handle coupling part 300 so as to pivotably support the razor cartridge 500 within a certain angle range for a fixed axis or an axis that moves within a certain range.

Also, the handle header 130 is selectively coupled to the handle coupling part 300 in the cartridge replaceable razor. In this case, the handle 100 may be provided with an operator (not shown) capable of operating the handle header 130. The user is able to release the coupling between the handle header 130 and the handle coupling part 300 by operating the operator.

The razor cartridge 500 according to an embodiment of the present disclosure includes a blade housing 510, a lubricating band 530, a clip 550, and a blade 1000.

The blade housing 510 includes a frame 511, a guard 513, and a cap 515. Here, the guard 513 is disposed in front (or in a positive X-axis direction of) the frame 511, and the cap 515 is disposed at rear (or in a negative X-axis direction) of the frame 511.

A central portion of the frame 511 is formed to be open upward. The frame 511 accommodates at least one blade 1000 in a longitudinal direction (Y-axis direction). When a plurality of blades 1000 is disposed at the frame 511, each blade 1000 may be arranged in a row in a transverse direction (X-axis direction) to the other blades 1000.

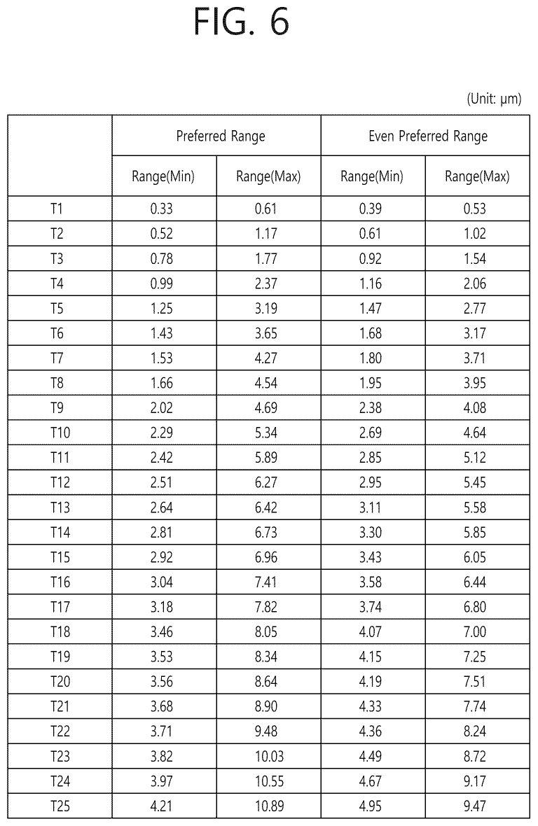

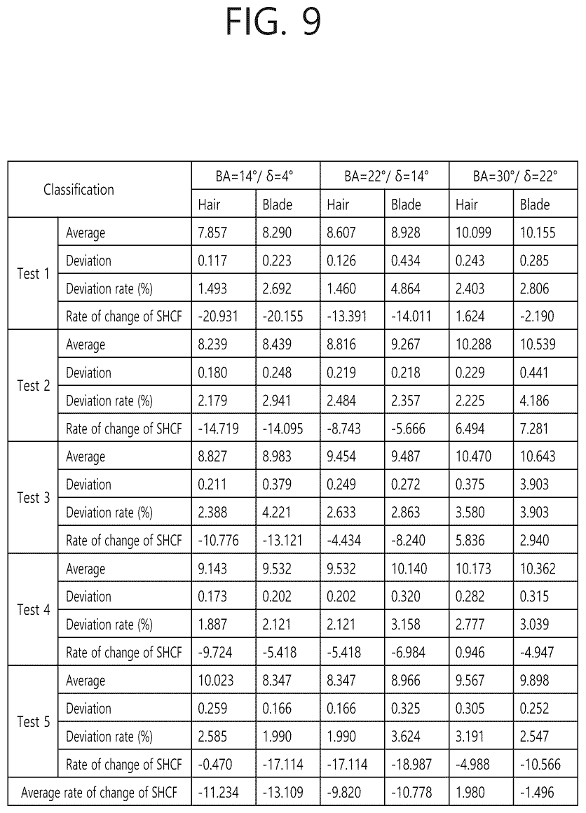

During shaving, the guard 513 comes into close contact with the user's skin surface S (see FIGS. 6 and 9) to pull the skin surface, thereby improving the shaving effect of the blade 1000. An embossed or intaglio pattern may be formed in an upper surface of the guard 513 so as to more effectively pull the user's skin surface S. The upper surface of the guard 513 may be formed of a material such as rubber and silicon. When the guard 513 includes a lubricating material, the guard 513 serves to pre-apply supplements for shaving to the skin before the body hair touches the blade 1000.

The lubricating band 530 exposed through a top of the razor cartridge 500 may be disposed at the cap 515. The lubricating band 530 includes a lubricating material, and allows the lubricating material to be applied to the skin surface S where the blade 1000 passes during shaving. The lubricating material may include components for protecting the skin surface S after shaving.

The clip 550 surrounds both sides of the frame 511 and is coupled to the blade housing 510. The clip 550 prevents separation of the blade 1000 from the blade housing 510.

The blade 1000 includes a base portion 1100, a bent portion 1200, and an edge portion 1300, as shown in FIGS. 4 and 5. The base portion 1100, the bent portion 1200, and the edge portion 1300 are distinguish each area of the blade 1000. Also, in detail, the blade 1000 includes a substrate 1500, a cutting edge 1600, and a coating layer 1700. In FIG. 4, the base portion 1100, the bent portion 1200, and the edge portion 1300 are shown as an integrated blade 1000, but aspects of the present disclosure are not limited thereto. Therefore, in another embodiment, the blade 1000 may be a welded blade to which the edge portion 1300 is attached by welding.

The base 1100 is supported by the blade housing 510. The bent portion 1200 is disposed between the edge portion 1300 and the base portion 1100 to thereby connect the base portion 1100 and the edge portion 1300 to each other. The bent portion 1200 extends forward (in the positive X-axis direction) from the base portion 1100. The edge portion 1300 extends along a bending direction of the bent portion 1200 that is bent from the base portion 1100. The edge portion 1300 is a region to substantially cut the body hair during shaving, and the cutting edge 1600 is formed at a tip of the edge portion 1300.

As shown in FIG. 5, the substrate 1500 forms the blade 1000 and is used as a base material for manufacturing the blade 1000. The substrate 1500 includes a substrate tip 1510, a first surface 1530 and a second surface 1550. The substrate tip 1510 is provided so that a final tip 1710 is substantially formed when the coating layer 1700 is formed. The substrate 1500 is mainly formed of stainless steel, but may also be formed of silicon or ceramic.

As shown in FIG. 6, values for optimal thickness of the substrate 1500 are presented in the form of a chart. At a time of manufacturing or using the blade 1000, numerical values for thickness of T1 to T25 are important. Here, Tx indicates a thickness of the substrate 1500 in a region x micrometers away from the substrate tip 1510. For example, T1 indicates a thickness of the substrate 1500 in a region 1 micrometer away from the substrate tip 1510. The separation distance and thickness regarding T1 to T25 are expressed in micrometers.

The table of FIG. 6 shows values of T4, T16, T20, and T25 that affect physical properties among the values of thickness of the substrate 1500 at a time of forming the cutting edge 1600 of the blade 1000.

In one embodiment of the present disclosure, the substrate 1500 has a thickness T4 of 1.16 to 2.06 micrometers measured at a distance of 4 micrometers away from the substrate tip 1510, and the substrate 1500 has a thickness T16 of 3.58 to 6.44 micrometers measured at a distance of 16 micrometers away from the substrate tip 1510.

Further, the substrate 1500 has a thickness T20 of 4.19 to 7.51 micrometers measured at a distance of 20 micrometers away from the substrate tip 1510, and the substrate 1500 has a thickness T25 of 4.95 to 9.47 micrometers measured at a distance of 25 micrometers away from the substrate tip 1510. Even in a case where the blade 1000 has an asymmetrical shape, a shape of the substrate 1500 used as the base material of the blade 1000 has a significant impact on the overall shape, shaving performance, and durability of the blade 1000. In particular, a thickness in a region of the substrate 1500 relatively close to the substrate tip 1510, such as T1 to T25, may play an important role in determining the characteristics of the blade 1000.

As shown in FIG. 5, the first surface 1530 and the second surface 1550 extend toward both sides of the substrate tip 1510. In one embodiment of the present disclosure, the first surface 1530 corresponds to one side facing the skin surface S during shaving, and the second surface 1550 corresponds to the other side opposite to the one side. The coating layer 1700 is formed on the first surface 1530 and the second surface 1550.

The cutting edge 1600 is formed at a tip region of the edge portion 1300, and is formed based on the formation of the substrate 1500 and the coating layer 1700 coated on the substrate 1500. The cutting edge 1600 performs a function of substantially cutting the body hair during shaving. At least a portion of the cutting edge 1600 is exposed through a top of the blade housing 1510 and comes into contact with body hair during shaving.

In one embodiment of the present disclosure, the coating layer 1700 includes a final tip 1710, a first facet 1730, and a second facet 1740. In addition, the coating layer 1700 further includes a third facet 1760. In addition, the coating layer 1700 further includes a fourth facet 1780 and a fifth facet 1790. The coating layer 1700 has a basic structure consisting of hard coating and resin coating. A total thickness of the coating layer 1700 has a range of about 5 nm to about 500 nm.

The coating layer 1700 of the blade 1000 includes a material based on CrC or Cr. Alternatively the coating layer 1700 may include a layer containing Carbon, a layer containing Boron, a layer containing Nitrogen, or a layer containing Oxide, or a material layer of a combination of at least some of these.

The final tip 1710 forms the tip of the cutting edge 1710. The final tip 1710 is spaced from the skin surface S during shaving. The first facet 1730 extends toward one side from the final tip 1710, forming the tip of the cutting edge 1710, and faces the skin surface S during shaving. The second facet 1740 extends toward the other side from the final tip 1710. Next, the third facet 1760 extends from the first facet 1730. In one embodiment of the present disclosure, the first facet 1730 and the third facet 1760 face the skin surface S. However, aspects of the present disclosure are not limited thereto, and the second facet 1740 may face the skin surface S. The first facet 1730, the second facet 1740, and the third facet 1760 shown in the present disclosure are formed in a straight line. However, aspects of the present disclosure are not limited thereto, and the first facet 1730, the second facet 1740, and the third facet 1760 may have a convex or concave shape. The fourth facet 1780 and the fifth facet 1790 are formed symmetrically with each other. In detail, the fourth facet 1780 extends from the second facet 1740, and the fifth facet 1790 extends from the third facet 1760. The blade 1000 according to an embodiment of the present disclosure has an asymmetrical shape. In one embodiment of the present disclosure, the blade 1000 is manufactured to have a symmetrical substrate 1500 and an asymmetrical coating layer 1700. However, aspects of the present disclosure are not limited thereto, and the blade 1000 may be manufactured so that the substrate 1500 also has an asymmetrical shape.

As described above, the asymmetric shape of the blade 1000 may be based on the shapes of the first facet 1730 and the third facet 1760. In addition, the asymmetric shape of the blade 1000 may be formed with including the third facet 1760. In one embodiment of the present disclosure, the first facet 1730 is formed within 1 micrometer from the final tip 1710. The second facet 1740 is formed within 50 micrometers from the final tip 1710. The third facet 1760 is formed within 50 micrometers from the final tip 1710.

Meanwhile, a first angle θ1 between the first facet 1730 and the second facet 1740 is an angle formed by the final tip 1710, affecting cut-in of the blade 1000 for the body hair. The first angle θ1 has a value between 50 degrees and 75 degrees, or, between 50 degrees and 70 degrees. A second angle θ2 between the first facet 1730 and the third facet 1760 is an angle formed by the area of the blade 1000 facing the skin surface S during shaving, affecting the magnitude of skin irritation to the skin surface S during shaving. The second angle θ2 has a value between 120 degrees and 165 degrees, or, between 130 degrees and 160 degrees. A third angle θ3 between an extension line of the second facet 1740 and an extension line of the third facet 1760 is an angle that determines the overall thickness of the blade 1000 after the first facet 1730. The third angle θ3 affects a procedure of the blade 100 to cut the body hair, that is, a procedure following a cut-in procedure. The third angle θ3 has a value between 25 degrees and 50 degrees, or, between 30 degrees and 45 degrees. The first, second, and third angles θ1, θ2, θ3 collectively determine the asymmetrical shape of the blade 1000, and may be the factors that determine an efficient angle δ which will be described later.

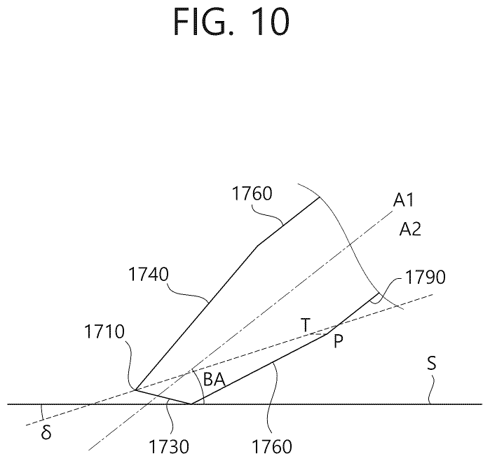

As shown in FIG. 10, in one embodiment of the present disclosure, the third facet 1760 and the fifth facet 1790 may be defined as a first intersection point P. A line A2 passing through the first intersection point P and a bisector of the final tip 1710 on a line parallel to the skin surface S may be defined as a second intersection point T. A distance between the first intersection point P and the second intersection point T has a value between 1 micrometer and 5 micrometers. In addition, a distance between the final tip 1710 and the second intersection point T has a value between 2 micrometers and 7 micrometers.

As shown in FIGS. 5 and 10, the distances of the first facet 1730, the second facet 1740, and the third facet 1760 from the final tip 1710 correspond to the optimal values for the asymmetrical shape and reduction in the cutting force. In addition, the first angle θ1 between the first facet 1730 and the second facet 1740, the second angle θ2 between the first facet 1730 and the third facet 1760, and the third angle θ3 between the extension line of the second facet 1740 and the extension line of the third facet 1760 correspond to the optimal values for the asymmetrical shape and reduction in the cutting force. In addition, a numerical value indicative of the distance between the first intersection point P and the second intersection point T also corresponds to an optimal value for the asymmetrical shape and reduction in the cutting force.

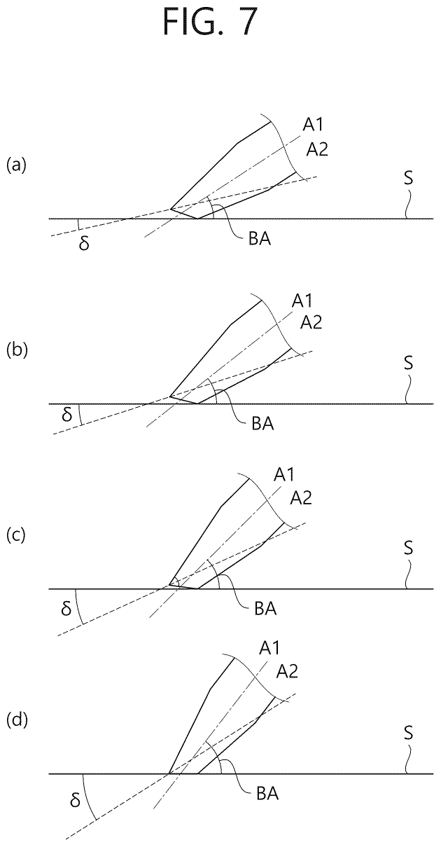

As shown in FIGS. 5 and 7, in one embodiment of the present disclosure, the blade 1000 having an asymmetric shape forms a blade angle BA between the skin surface S and a line A1 passing through a bisector of the edge portion 1300 and an efficient angle δ between the skin surface S and a line A2 passing through a bisector of the final tip 1710. The efficient angle δ is associated with a direction of force applied to the final tip 1730 when the blade 1000 cuts in the body hair, and the blade angle BA is associated with a direction of force applied to all over the cutting edge 160 after the cut-in of the blade 1000.

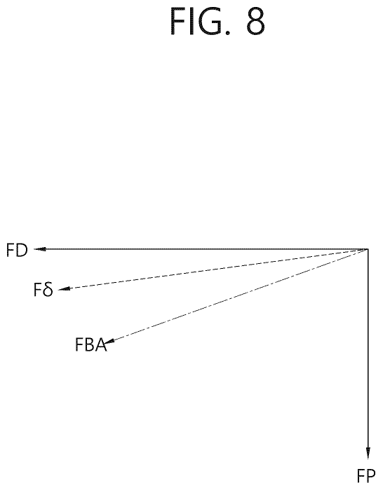

As shown in FIG. 8, a vector FBA for the blade angle BA and a vector F for efficient angle δ are based on a sum of a vector of a shaving direction FD and a vector of a pressing force FP applied to the skin surface during shaving.

In one embodiment of the present disclosure, the blade angle BA is formed greater than the efficient angle δ. Specifically, the efficient angle δ may be less than 10 degrees, and the blade angle BA may be 14 to 22 degrees, or, 17 degrees or less. That is, the blade angle BA is formed greater than the efficient angle δ, as in the aforementioned range of numerical values.

In FIG. 7, (a) show a case where the efficient angle δ is 9 degrees when the blade angle BA is 17 degrees, (b) shows a case where the efficient angle δ is 14 degrees when the blade angle BA is 22 degrees, (c) shows a case where the u efficient angle δ is 19 degrees when the blade angle BA is 27 degrees, and (d) shows a case where the efficient angle δ is 40 degrees when the blade angle BA is 45 degrees. As shown in FIG. 7, compared to the final tip 1710 in the case (a), the final tip 1710 in each of the cases (b) to (d) may increase a cutting force (increases a cutting resistance) as approaching the skin surface S, thereby resulting in pulling of the body hair and uncomfortable shaving sensation.

This is proven on the basis of the test result chart in FIG. 9 showing the test results of the embodiments of FIG. 7. The test result chart in FIG. 9 show Single Hair Cutting Force (SHCF) values measured at five tests in cases where the blade angle BA is 14 degrees and the efficient angle δ is 4 degrees, where the blade angle BA is 22 degrees and the efficient angle δ is 14 degrees, and where the blade angle BA is 30 degrees and the efficient angle δ is 22 degrees. Here, a SHCF refers to a force required for the blade 1000 to cut one body hair and corresponds to a cutting force.

Here, in FIG. 9, the SHCF is described on the unit basis of gram force (gf), and is classified into two types including SFCH applied to the body hair and SFCH applied to the blade 1000. Specifically, the SHCF on the body hair side represents a numerical value based on a force applied to the body hair, and the SHCF on the blade side represents a numerical value based on a force applied to the blade 1000.

Meanwhile, in the test result chart of FIG. 9, a rate of change of SHCF refers to the rate of how much a SHCF value vary in each test with a conventional symmetric blade, especially when a blade angle BA is 22 degrees and the efficient angle δ is 22 degrees. The rate of change of SHCF is described on the unit basis of a percentage (%).

Looking at the test results, when the blade angle BA is 14 degrees and the efficient angle δ is 4 degrees, the rate of change of SHCF according to the five tests is −11.234% and −13.109% for the body hair and the blade 1000, respectively. Also, when the blade angle BA is 22 degrees and the efficient angle δ is 14 degrees, the rate of change of SHCF is −9.820% and −10.778% for the body hair and the blade 1000, respectively. Lastly, when the blade angle BA is 30 degrees and the efficient angle δ is 22 degrees, the rate of change of SHCF is 1.980% and −1.496% for the body hair and the blade 1000, respectively.

As the rate of change of SHCF has a larger negative value, the cutting force decreases, so that body hair is less pulled during shaving and a user may feel comfortable during shaving. As described in the test results of FIG. 9, in the cases where the blade angle BA is 14 degrees and the efficient angle δ is 4 degrees and where the blade angle BA is 22 degrees and the efficient angle δ is 14 degrees, a relatively less cutting force may be provided, compared to the case where the blade angle BA is 30 degrees and the efficient angle δ is 22 degrees. The blade angle BA may be 14 degrees to 22 degrees as limited in an embodiment of the present disclosure, and the efficient angle δ is relatively smaller than the blade angle BA and less than 10 degrees. Although not shown in FIG. 9, when the blade angle BA is 22 degrees, the experimentally efficient angle δ may be less than 10 degrees. That is, if the efficient angle δ is adjusted according to a change in the asymmetric cutting edge 1710 and a change in the blade angle BA and then becomes less than 10 degrees, it is possible to reduce a cutting force and minimize skin irritation.

Accordingly, in a case where the cutting edge 1600 of the blade 1000 is formed asymmetrically, the blade angle BA between the skin surface S and the line A1 passing through the bisector of the edge portion 1300 is greater than the efficient angle δ between the skin surface S and the line A2 passing through the bisector of the final tip 1710, so that a cutting force can be reduced according to shaving characteristics and irritation to the skin surface S can be minimized.

While embodiments of the present disclosure have been described with reference to the accompanying drawings, it will be understood by those of ordinary skill in the art that specific implementations may be varied and modified without departing from the scope of the present disclosure. Accordingly, it should be understood that the embodiments described above are merely examples for purposes of description and do not limit the present disclosure in any respect. Therefore, the scope of the present disclosure is limited solely by the following claims and their equivalents. Accordingly, the scope of the present disclosure is defined by the appended claims rather than the foregoing description and the exemplary embodiments described therein. Various modifications made within the meaning of an equivalent of the claims of the invention and within the claims are to be regarded to be in the scope of the present disclosure.

What is claimed is:

1. A razor cartridge comprising:
at least one blade comprising an edge portion and a cutting edge formed at a tip of the edge portion; and
a blade housing configured to receive the at least one blade in a longitudinal direction so that at least a portion of the cutting edge is exposed upwardly,
wherein the at least one blade comprises:
a substrate comprising a substrate tip, a first surface extending toward one side from the substrate tip, and a second surface extending toward the other side from the substrate tip; and
a coating layer formed on the substrate and configured to form the cutting edge,
the coating layer comprising:
a first facet extending toward one side from a final edge forming a tip of the cutting edge and configured to face a skin surface during shaving; and
a second facet extending toward the other side from the final edge and opposite to the first facet,
wherein a blade angle (BA) between the skin surface and a line passing through a bisector of the edge portion is greater than an efficient angle (δ) between the skin surface and a line passing through a bisector of the final tip.

2. The razor cartridge of claim 1, wherein the efficient angle (δ) is less than 10 degrees.

3. The razor cartridge of claim 1, wherein the blade angle (BA) is 22 degrees or less.

4. The razor cartridge of claim 1, wherein the blade angle (BA) is 17 degrees or less.

5. The razor cartridge of claim 1, wherein the final tip is configured to be spaced apart from the skin surface during shaving.

6. The razor cartridge of claim 1, wherein the first facet is formed within 1 micrometer away from the final tip.

7. The razor cartridge of claim 1, wherein the second facet is formed within 50 micrometers away from the final tip.

8. The razor cartridge of claim 1, wherein an angle between the first facet and the second facet is in a range of 50 degrees to 75 degrees.

9. The razor cartridge of claim 1, wherein:
the blade further comprises a third facet extending from the first facet, and
an angle between the first facet and the third facet is in a range of 120 degrees to 165 degrees.

10. The razor cartridge of claim 1, wherein:
the blade further comprises a third facet extending from the first facet, and
an angle between an extension line of the second facet and an extension line of the third facet is in a range of 25 degrees to 50 degrees.

11. The razor cartridge of claim 1, wherein:
the blade further comprises a third facet extending from the first facet, and
the third facet is formed within 50 micrometers away from the final tip.

12. The razor cartridge of claim 1, wherein:
the blade further comprises a third facet extending from the first facet and a fifth facet extending from the third facet,
a point where the third facet and the fifth facet cross each other is defined as a first intersection point P,
a point where a parallel line to the skin surface and passing through the first intersection point P and a line A2 passing through the bisector of the final tip cross each other is defined as a second intersection point T, and
a distance between the first intersection point P and the second intersection point T is in a range of 1 micrometer to 5 micrometers.

13. The razor cartridge of claim 12, wherein a distance between the second intersection point T and the final tip is in a range of 2 micrometers to 7 micrometers.

14. A razor cartridge comprising:
at least one blade having an edge portion and a cutting edge formed at a tip of the edge portion; and
a blade housing configured to receive the at least one blade in a longitudinal direction so that at least a portion of the cutting edge is exposed through a top of the blade housing,
wherein the at least one blade comprises:
a substrate comprising a substrate tip, a first surface extending toward one side from the substrate tip, and a second surface extending toward the other side from the substrate tip; and
a coating layer formed on the substrate and configured to form the cutting edge,
the coating layer comprising:
a first facet extending toward one side from a final edge forming a tip of the cutting edge and configured to face a skin surface during shaving; and
a second facet extending toward the other side from the final edge and opposite to the first facet,
wherein an efficient angle (δ) between the skin surface and a line passing through a bisector of the final tip is less than 10 degrees.
